(19) United States
(12) Patent Application Publication
(10) Pub. No.: US 2008/0158386 A1
(43) Pub. Date: Jul. 3, 2008

(54) IMAGE RESTORATION DEVICE

(76) Inventor: Takanori Miki, Kanagawa (JP)

Correspondence Address: Frank Pincelli;Patent Legal Staff, Eastman Kodak Company, 343 State Street, Rochester, NY, 14650-2201, US

(21) Appl. No.: 11/756,673

(22) Filed: Jun. 1, 2007

(30) Foreign Application Priority Data
Dec. 27, 2006 (JP) 2006-351964

(51) Int. Cl. H04N 1/21

(52) U.S. Cl. 348/231.3; 348/E05.007

(57) ABSTRACT

Camera shake which arises during flash (or stroboscopic) photography is corrected. A flashlight-exposed region and an unexposed region are distinguished from each other during flash photography. The flashlight-exposed region is not subjected to camera shake correction, and only the unexposed region is subjected to camera shake correction. After camera shake correction, the flashlight-exposed region having not undergone camera shake correction and the unexposed region having undergone camera shake correction are merged with each other. During merging operation, the flashlight-exposed region is merged over a blending range, thereby blurring a boundary between the regions.

### CROSS REFERENCE TO RELATED APPLICATIONS

This application claims priority to Japanese Patent Application No. 2006-351964 filed on Dec. 27, 2006, which is incorporated herein by reference in its entirety.

### FIELD OF THE INVENTION

The present invention relates to an image-capturing device, and more particularly to an image-capturing device having a flash device.

### BACKGROUND OF THE INVENTION

A recent digital camera is equipped with a camera shake correction mechanism for reducing camera shake which arises during photographing. A camera shake correction mechanism performs electronic camera shake correction, optical camera shake correction, camera shake correction of image sensor shift type, and the like. According to electronic camera shake correction, a photographable area is narrowed to a given size, and images are read into buffer memory during photographing. A first captured image is compared with subsequently captured images, thereby computing the amount of the first image that extends off the photographable area. Photographing is performed by means of automatically shifting the photographable area, and captured images are recorded. According to optical camera shake correction, a correction lens equipped with a vibration gyroscopic mechanism is incorporated into a lens, and the correction lens is shifted in a direction where camera shake is canceled, thereby correcting an optical axis. According to camera shake correction of image sensor shift type, camera shake is detected by means of a vibration gyroscopic mechanism, and an image sensor, such as a CCD, CMOS, or the like, is shifted in accordance with camera shake, thereby correcting an optical axis. There has also been proposed a method for correcting camera shake by means of processing a photographed image, to restore an original image. A known method is to use PSF (Point Spread Function: PSF), which represents the amount of camera shake, in processing to be performed after photographing operation.

Meanwhile, when the brightness of a subject is low, an image is photographed while flashlight is being fired by means of driving a flash device (or a stroboscope). However, even in the case of flash photography, camera shake is considered to be corrected. For instance, when a portrait or the like is captured through flash photography, a picture of a person irradiated with flashlight is exposed for a short period of time during which flashlight is being fired. However, a background—which is irradiated not with flashlight but with light from another light source—is exposed until a shutter is actually closed. Moreover, when a person is irradiated with light from another light source, a portrait is formed at a rate of contribution of flashlight to light from the other light source. In the end, a PSF for an area of the person differs from another PSF for an area of the background in the portrait. When an image is restored by use of a single PSF, unwanted blurring appears in the area of the person.

FIGS. 8A to 8C show conceptual renderings pertaining to correction of camera shake performed during flash photography. FIG. 8A shows a field of view where a background and a person coexist. It is assumed that the brightness of the field of view is low and that firing of flashlight is required. When flash photography is performed by means of driving a flash device, a person located at a relatively short distance is irradiated with flashlight. The background located at a relatively long distance is irradiated with not flashlight but light from another light source. A period of time during which the person is exposed becomes essentially equal to a period of time during which the person is actually irradiated with flashlight, and hence camera shake is less likely to arise. Further, a period of time during which the background is exposed corresponds to a period of actual exposure time determined by open-and-close of a shutter. Hence, shake induced when the user actuates a camera affects photography directly, which results in occurrence of camera shake. FIG. 8B shows a state where camera shake does not arise in the person but camera shake 700 has arisen in the background. Consequently, when camera shake is corrected during photography, the camera shake in the background can be prevented as shown in FIG. 8C, but camera shake 800 which has not originally appeared in the person arises.

JP 2004-205802 A describes, with a view toward providing a camera system which yields a high correction effect regardless of firing/non-firing of flashlight, by computing a PSF when flashlight is fired; correcting the PSF in accordance with flash information pertaining to firing of flashlight after computation of the PSF; and restoring an image by use of the corrected PSF.

JP 7-295005 A describes deactivation of a blurred image correction device during flash photography.

JP 2004-205802 A describes correction of a PSF during flash photography. However, when an image is restored by use of a corrected PSF, a person is blurred to some extent by means of restoration processing. Moreover, there is also a problem of incapability of correcting the blur of a background. According to JP 7-295005 A, the blurred image correction device is not activated during flash photography. Hence, although the person is not blurred, by virtue of camera shake correction, the camera shake of the background which is present during photography still remains.

### SUMMARY OF THE INVENTION

Accordingly, the present invention provides an apparatus capable of performing original image restoration processing, such as camera shake correction or the like, with high accuracy.

The present invention provides an image restoration apparatus for subjecting an image captured through photography to restoration processing, the apparatus comprising:

detection means for detecting a flashlight-exposed region from an image captured by firing flashlight during photography; and

processing means for subjecting to restoration processing only an unexposed region of the captured image exclusive of the flashlight-exposed region detected by the detection means.

In the present invention, the processing means may extract the flashlight-exposed region of the captured image, subject the unexposed region of the captured image to restoration processing, and merge the flashlight-exposed region having not undergone restoration processing with the unexposed region having undergone restoration processing.

In the present invention, the processing means may extract the flashlight-exposed region of the captured image, extract the unexposed region after having subjected the captured image to restoration processing, and merge the extracted regions with each other.

According to the present invention, even when flash photography is effected by activating a flash emission device, such as a flash device or a strobe, only an unexposed region is subjected to image restoration processing. Hence, high-precision restoration processing can be performed. According to the present invention, even when, for instance, only the principal subject, is exposed to flashlight, camera shake in a background area which is not exposed to flashlight is corrected, and an image whose primary subject is free of blurriness is acquired.

The invention will be more clearly comprehended by reference to the embodiment provided below. However, the scope of the invention is not limited to the embodiment.

### BRIEF DESCRIPTION OF THE DRAWINGS

A preferred embodiment of the present invention will be described in detail by reference to the following figures, wherein:

FIG. 1 is a block diagram of a digital camera of an embodiment of the present invention;

FIG. 2 is a block diagram of the digital camera of the embodiment of the present invention;

FIG. 3 is a flowchart of processing performed during recording operation of the present embodiment;

FIG. 4 is a flowchart of processing performed during another recording operation of the present embodiment;

FIG. 5 is a flowchart of processing performed during restoration of the present embodiment;

FIG. 6 is a descriptive view of a distance function;

FIG. 7 is a descriptive view of operation for smoothing a mask image;

FIG. 8 is a descriptive view for correcting camera shake in an image captured through photography involving flashlight; and

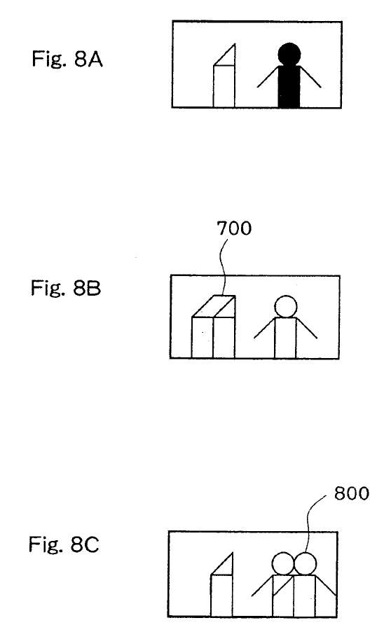

FIG. 9 is a descriptive view of setting of a blend range.

### DETAILED DESCRIPTION OF THE INVENTION

An embodiment of the present invention will be described hereunder by reference to the drawings while taking as an example a digital camera equipped with a camera shake correction mechanism.

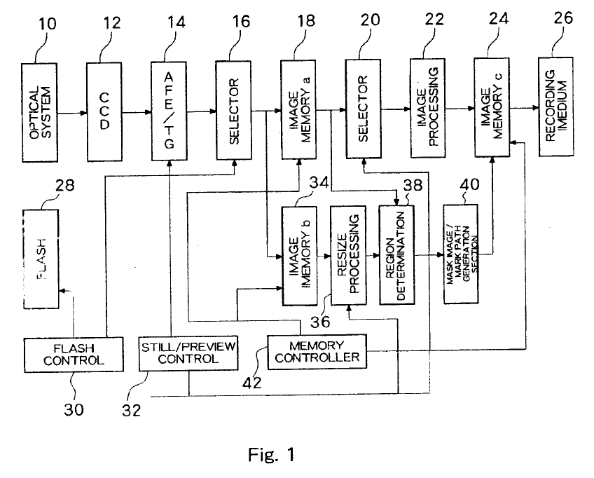

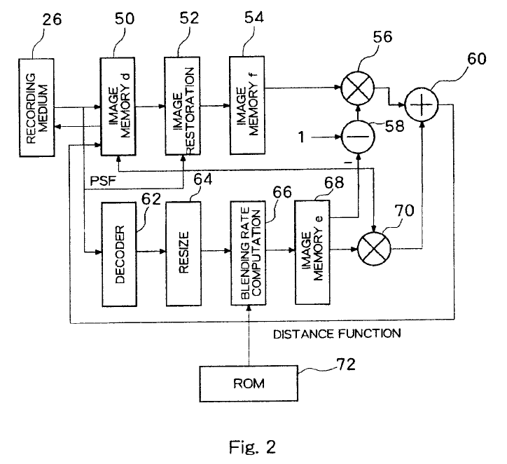

FIGS. 1 and 2 show block diagrams pertaining to the configuration of the digital camera of the embodiment. FIG. 1 shows a unit of the digital camera for recording captured images into a recording medium, and FIG. 2 shows a unit which performs restoration processing for reading the image recorded in the recording medium and subjecting the previously read image to camera shake correction. The digital camera of the present embodiment has a camera shake correction mechanism which processes a captured image after photography, and restores an original image from the captured image by use of a PSF.

In FIG. 1, an optical system 10 has a group of lenses, a shutter, and a diaphragm; and converges light from a subject into an image on an image sensor such as a CCD or the like.

A CCD 12 converts the light from the subject into an electrical signal and outputs the electrical signal as an analog image signal.

An analog front-end (AFE)/timing generator (TG) 14 converts an analog image signal into a digital image signal. The digital image signal is stored into image memory a 18 or image memory b 34 via a selector 16. The selector 16 selects either the image memory a 18 or the image memory b 34 as a location where the digital image signal is stored. Selection is carried out in accordance with a flash control signal from a flash control section 30. In the present embodiment, an image captured when flashlight is not fired is in principle stored in the image memory b 34, and an image captured when flashlight is fired is stored in the image memory a 18.

The flash control section 30 activates a flash device 28 and supplies the selector 16 with the flash control signal.

A still image (Still)/preview (preview) control section 32 switches between a still image and a preview image according to an operation signal from a release button. When the user has activated the power of the digital camera, the still image/preview control section 32 switches the mode to a preview mode. When the user actuates the release button, the still image/preview control section 32 switches the mode to the still image mode. A switch signal from the still image/preview control section 32 is supplied to the AFE/TG 14. The AFE/TG 14 subjects an analog image signal from the CCD 12 to thinning in a preview mode, thereby generating a digital image signal. Thinning operation performed in the preview mode is for displaying an image in a rear LCD of predetermined size (e.g., 2.5 inches) of the digital camera.

A resize processing section 36 resizes the image stored in the image memory b 34. Specifically, when the image stored in the image memory b 34 is a thinned preview image, the preview image is enlarged through interpolation until it attains the same size as that of the image captured in the still image mode.

A region determination section 38 discriminates a flashlight-exposed region from an unexposed region in the resized preview image. To this end, the region determination section 38 is supplied, from the image memory a 18, with an image captured when a subject is irradiated with the flashlight. The region determination section 38 compares the image captured when the subject is irradiated with the flashlight with an image captured when the subject is not irradiated with the flashlight, thereby discriminating the flashlight-exposed region from the unexposed region.

A mask image/mask path generation section 40 generates a mask image or mask path by use of a result of discrimination performed by the region determination section 38.

An image-processing section 22 subjects the image (an image captured when the subject has been exposed to flashlight), which has been read from the image memory a 18 and supplied via a selector 20, to processing such as edge enhancement, white balance adjustment, γ correction, JPEG compression, and the like; and stores the processed image into image memory c 24. The mask image or mask path generated by the mask image/mask path generation section 40 is also stored in the image memory c 24 in association with the image. The captured image stored in the image memory c 24 and the mask image (or the mask path) associated therewith are stored in a recording medium 26 such as flash memory or the like. A memory controller 42 controls writing and reading image data into and from the image memory a 18, the image memory b 34, and the image memory c 24.

In FIG. 2, the captured image stored in the recording medium 26 and the mask image associated with the image are read and stored in image memory d 50.

An image restoration section 52 reads a captured image stored in the image memory d 50 and performs restoration processing through use of the PSF determined from information about camera shake having arisen during photography. Restoration processing using a PSF is known. The PSF is acquired by expressing the locus of movement of a point light source induced by camera shake as a distribution function of brightness achieved for each of the pixels of the image sensor. The steepest-descent method has already been known as example image restoration using a PSF, and the general description of the method is as follows. Specifically, ∇J of a captured image is computed. Here, J denotes the result of evaluation of a general inverted filter and is defined as J=∥G−HF∥², provided that a deteriorated image corresponding to a captured image is taken as G; a restored image is taken as F; and a deterioration function is taken as H. The equation signifies that the result of evaluation J is determined as the magnitude of a difference between an image HF acquired by application of the deterioration function H to the restored image F and an actual deteriorated image G. When the restored image has been properly restored, a relationship of HF=G is theoretically achieved, and the result of evaluation comes to zero. The smaller the result of evaluation J, the better the restoration of the restored image F. According to the steepest-descent method, iterative operation is repeated until the magnitude of ∇J, which is the gradient of the result of evaluation J; namely, a square of the norm of ∇J, falls below a threshold value. At a point in time when the square of the norm has fallen below the threshold value, iterative operation is terminated, to acquire a restored image F. The result of evaluation J is computed from the captured image (the deteriorated image G), the restored image F, and a PSF; i.e., the deterioration function H; and ∇J is further computed. The PSF is computed from the amount of motion of an image attributable to hand movements derived from a magnification of an image of an image-capturing system as well as from an angular velocity detected by a gyroscope attached to the digital camera. The square of the norm of the computed ∇J is compared with a threshold value, thereby determining whether or not the square is equal to or less than the threshold value. When the square is equal to or less than the threshold value, the norm of ∇J is deemed to have converged at an optimum solution in a sufficiently small manner, and the iterative operation is completed. Meanwhile, when the square of the norm of ∇J exceeds the threshold value, restoration is deemed to have not yet been sufficient, and the iterative operation is continued. Such iterative operation is performed over the entire region of a captured image. Specifically, the flashlight-exposed region and the unexposed region in the captured image are subjected to restoration processing. The restored flashlight-exposed region is discarded by a multiplier 56 disposed in a subsequent stage. The captured image having undergone image restoration processing is stored in image memory f 54.

A decoder 62 reads a mask image which is stored in the recording medium 26 and has undergone JPEG compression; decodes the previously read image; and supplies the decoded image to a resize processing section 64. Since the mask image is one-bit data of 0 or 1, the image may be stored in the recording medium 26 through run-length encoding or JBIG compression rather than JPEG compression. Alternatively, the image may also be stored as control point information about a Bezier curve as in the case of path information about known image processing software.

The resize processing section 64 subjects the mask image to interpolation enlargement processing so as to make the image identical in size with the captured image. This processing corresponds to inverted conversion of thinning performed at the time of generation of a preview image. When the mask image is generated from the preview image, resize processing is required. However, when the mask image has already undergone resize processing, the image does not need to be re-subjected to resize processing. A decoded mask image is output in unmodified form.

A blending rate computing section 66 processes a mask image such that a boundary of the mask image; namely, a boundary between a flashlight-exposed region and an unexposed region, changes continually. The boundary is processed by use of a distance function previously stored in ROM 72. The distance function defines a distance up to which a continual change is allowed, with respect to the boundary that is taken as a reference point. For instance, a range of a few pixels from the reference point can be taken as a range of continual change. A distance is defined as a distance between the center of a pixel of interest and the center of the nearest boundary pixel from a flashlight-exposed region toward an unexposed region. A mask image whose boundary portion changes continually is stored in image memory e 68.

A multiplier 70 performs multiplication of the captured image (a captured image not having been restored) stored in the image memory d 50 by the mask image stored in the image memory e 68. Specifically, a pixel value of each of the pixels of the captured image is multiplied by a corresponding pixel value of the mask image. In the mask image, a flashlight-exposed region assumes a value of 1, and an unexposed region assumes a value of 0. Hence, the multiplier 70 has the function of extracting a flashlight-exposed region from a captured image which has not been restored.

A subtractor 58 computes a difference between a reference image, all pixels of which assume a value of 1, and a mask image. In the mask image, the flashlight-exposed region assumes a value of 1, and the unexposed region assumes a value of 0. Hence, an inverted mask image, where a flashlight-exposed region assumes a value of 0 and an unexposed region assumes a value of 1, is generated by means of computing the difference between the reference image and the mask image.

The multiplier 56 multiplies the captured image, which is stored in the image memory f 54 and has undergone restoration processing, by the inverted mask image. Specifically, the multiplier 56 computes a logical AND product between each of pixel values of the captured image having undergone restoration processing and a corresponding pixel value of the inverted mask image. In the inverted mask image, the flashlight-exposed region assumes a value of 0, and the unexposed region assumes a value of 1. Hence, the multiplier 56 has the function of extracting an unexposed region from the captured image having undergone restoration processing. Specifically, the flashlight-exposed region of the captured image having undergone restoration processing is discarded, and only the unexposed region is left.

An adder 60 adds an output from the multiplier 56 to an output from the multiplier 70, and stores a result of addition into the image memory d 50. The output from the multiplier 56 corresponds to the unexposed region having undergone restoration processing in the captured image, and the output from the multiplier 70 corresponds to the flashlight-exposed region not having undergone restoration processing in the captured image. By addition of the outputs, there is produced an image in which the unexposed region having undergone restoration processing is merged with the flashlight-exposed region not having undergone restoration processing.

Processing of the present embodiment will be described in more detail hereunder. Processing of the present embodiment comprises first processing for recording a captured image by means of discriminating a flashlight-exposed region from an unexposed region in the captured image; and second processing for restoring only the unexposed region of the captured image and merging the restored region to the flashlight-exposed region not having undergone restoration processing in the captured image.

First processing will now be described.

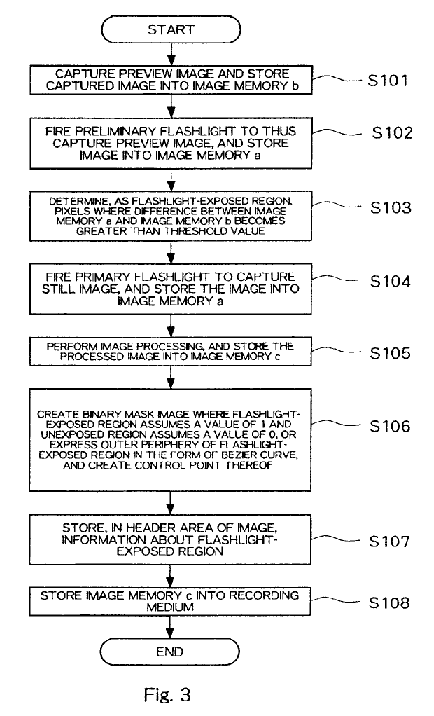

FIG. 3 shows a flowchart of a first processing. First, the power of the digital camera is activated, to acquire a preview image. A preview image is an image which is thinned and reduced in size as compared with a still image captured during actual photography. In accordance with a control signal from the flash control section 30, the selector 16 stores the preview image into the image memory b 34, because the flash device 28 is not activated.

Next, the flash device 28 is activated to fire preliminary flashlight. Preliminary flashlight is known; namely, prior to firing of primary flashlight, flashlight of a predetermined quantity of light is fired, and light reflected from a subject is received, thereby controlling the quantity of primary light to be fired. Since the flash device 28 is actuated in accordance with a control signal from the flash control section 30, the selector 16 stores a preview image captured during firing of preliminary flashlight into the image memory a 18. By means of this processing, the preview image captured during firing of preliminary flashlight is stored in the image memory a 18, and a preview image captured without firing preliminary flashlight is stored in the image memory b 34.

The preview image captured during firing of preliminary light stored in the image memory a 18 is read and supplied to the region determination section 38. The preview image captured without firing preliminary flashlight stored in the image memory b 34 is read and supplied to the resize processing section 36. Since both images are preview images, the resize processing section 36 supplies the image, which has been captured without firing preliminary flashlight and is stored in the image memory b 34, to the region determination section 38 without subjecting the image to resizing in accordance with the control signal from the still image/preview control section 32. The region determination section 38 compares the preview image captured during firing of preliminary flashlight with the preview image captured without firing preliminary flashlight. Specifically, the region determination section 38 computes a difference between each of pixels constituting the preview image (the image in the image memory a 18) captured during firing of preliminary flashlight and a positionally-corresponding pixel among pixels constituting the preview image captured without firing preliminary flashlight (the image in the image memory b 34); and determines a pixel whose difference exceeds a predetermined threshold value as a pixel irradiated with flashlight (S103). A result of determination is supplied to the mask image/mask path generation section 40.

After detection of a portion of the preview image irradiated with preliminary flashlight, the flash device 28 is activated to fire primary flashlight, to acquire a still image. Since the flash device 28 is activated in accordance with the control signal from the flash control section 30, the selector 16 stores the image captured during firing of primary flashlight in the image memory a 18. The image captured during firing of primary flashlight is an image captured by the user. The image-processing section 22 subjects the image to processing, such as white balance adjustment processing, edge enhancement processing, JPEG compression processing, and the like, and the processed image is stored in the image memory c 24 (S105).

In accordance with the result of determination rendered by the region determination section 38, the mask image/mask path generation section 40 generates a binary mask image in which the flashlight-exposed region of the preview image assumes a value of 1 and the unexposed region assumes a value of 0. Alternatively, the mask image/mask path generation section 40 expresses an outer periphery of the flashlight-exposed region by means of a Bezier curve or the like and generates, as a mask path, a group of dots constituting the curve (S106). The binary mask image or the mask path is stored in the image memory c 24. When the mask image or the mask path is stored in the image memory c 24, information about the binary mask image (or the mask path) is stored as information about the flashlight-exposed region in a header area of the image that has undergone image processing of the image processing section 22 and captured during firing of primary flashlight (S107). The image—where information about the binary mask image (or the mask path) is added to the header area—is stored in the recording medium 26 (S108). The mask image is not necessarily added to the header area of the captured image. In short, the essential requirement is to store the mask image such that the captured image and the mask image thereof are associated with each other in a one-to-one correspondence. The mask image may also be embedded into a captured image in the form of a watermark image.

Through processing mentioned above, information specifying the flashlight-exposed region and the unexposed region is stored and memorized in the header area of the captured image. The information specifying the flashlight-exposed region and the unexposed region is detected from a preview image. Since the preview image and the captured image differ in size from each other, the preview image cannot be applied directly to a captured image. The information, which is acquired from the preview image and specify the flashlight-exposed region and the unexposed region, must be resized so that the preview image can be applied to a captured image.

In processing shown in FIG. 3, the flashlight-exposed region and the unexposed region are discriminated from each other by use of preliminary flashlight fired by the flash device 28. However, the flashlight-exposed region and the unexposed region can also be discriminated from each other without use of preliminary flashlight.

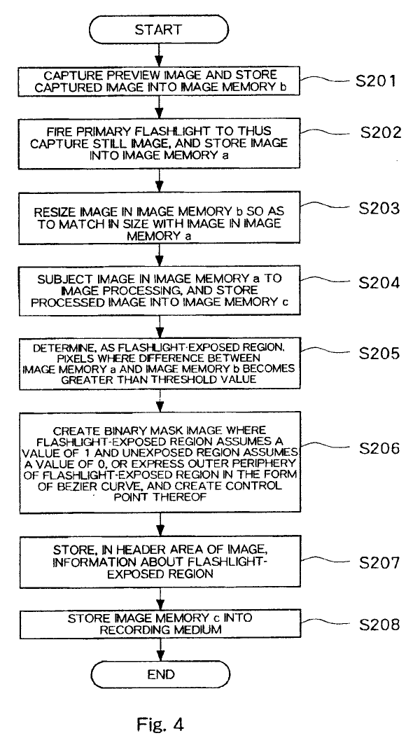

FIG. 4 shows a flowchart of the first processing which does not use preliminary flashlight. First, a preview image is stored in the image memory b 34 (S201). Next, the flash device 28 is caused to fire primary flashlight in response to actuation of the release button performed by the user, to photograph a still image and store the captured image into the image memory a 18. The preview image stored in the image memory b 34 is an image of small size that has been thinned for previewing purpose, and hence is interpolated and enlarged by the resize processing section 36 so as to become equal in size to the captured image (S203). The resized preview image is supplied to the region determination section 38. The image stored in the image memory a 18; namely, the image captured during firing of primary flashlight, is also supplied to the region determination section 38. After having undergone white balance adjustment, edge enhancement processing, JPEG compression processing, and the like, in the image processing section 22, the image is stored in the image memory c 24 (S204).

The region determination section 38 compares the image—which is read from the image memory a 18 and has been captured during firing of primary flashlight—with the resized preview image which is read from the image memory b 34 and has been captured without firing flashlight; and determines pixels whose differences exceed a predetermined threshold value as pixels irradiated with flashlight (S205). A result of determination is supplied to the mask image/mask path generation section 40. The mask image/mask path generation section 40 generates, as a mask image, a binary mask where a flashlight-exposed region assumes a value of 1 and an unexposed region assumes a value of 0. Alternatively, the mask image/mask path generation section 40 expresses an outer periphery of the flashlight-exposed region by means of a Bezier curve or the like and generates, as a mask path, a group of dots constituting the curve (S206). The binary mask image (or the mask path) is stored in the image memory c 24. At this time, information about the binary mask image or the mask path is stored as information about the flashlight-exposed region in a header area of the image that has undergone image processing of the image processing section 22 and captured during firing of primary flashlight (S207). The image information stored in the image memory c 24; namely, image—where information about the binary mask image (or the mask path) is added to the header area—is stored in a recording medium 26 (S208). Through processing mentioned above, the information specifying the flashlight-exposed region and the unexposed region is stored and memorized in the header area of the captured image. The information specifying the flashlight-exposed region and the unexposed region is detected from the captured image and the resized preview image. The information specifying the flashlight-exposed region and the unexposed region can be applied directly to the captured image.

In processing shown in FIGS. 3 and 4, camera shake information detected by a gyroscopic sensor when photographing is performed by causing the flash device 28 to fire primary flashlight is stored as a PSF in the recording medium 26. The PSF may also be stored in the header area of the captured image as in the case of the mask image, or stored in association with a captured image.

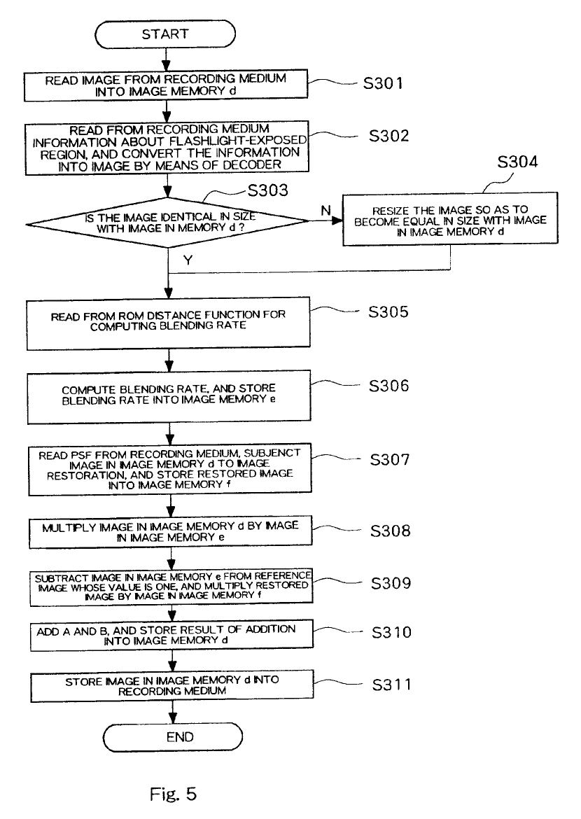

FIG. 5 shows flowchart of a second processing. In second processing, only the unexposed region that is not irradiated with flashlight is subjected to restoration processing when the original image is restored from the captured image by use of a PSF. The user determines, as necessary, whether or not image restoration is to be performed. Specifically, a list of captured images is displayed on the rear LCD of the digital camera, and by means of a cursor, buttons, and the like, of the digital camera the user selects a captured image desired to be subjected to image restoration. Selection performed by the user may also be facilitated on condition that each of the captured images is stored in the recording medium 26 with addition of PSF information; that the PSF satisfies predetermined conditions; and that only captured images which can be restored through use of a PSF are displayed on the rear LCD along with specific marks. Specifically, a group of captured images provided with specific marks is a group of images that can be subjected to camera shake correction, and the user selects a desired image from the group of images, to specify an image to be restored. The captured image specified to be subjected to image restoration is read from the recording medium 26 and stored in the image memory d 50 (S301). Since the information about the flashlight-exposed region and the unexposed region is added as information about a mask image (or a mask path) in the header area of the captured image, this information is read from the header area and decoded by a decoder 62 (S302).

Next, a determination is made as to whether or not a mask image acquired by decoding the information is identical in size with the captured image stored in the image memory d 50 (S303). As mentioned previously, the mask image created by the method shown in FIG. 3 is smaller than the captured image created from the preview image. The mask image created by the method shown in FIG. 4 is identical in size with the captured image created by means of resizing the preview image. When the mask image is not identical in size with the captured image, the mask image is interpolated and enlarged by the resize processing section 64 so as to become identical in size with the captured image (S304). After the mask image has been made identical in size with the captured image, the mask image is supplied to the blending rate computing section 66.

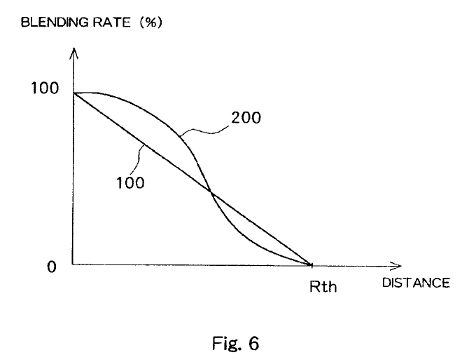

The blending rate computing section 66 reads a distance function which has been stored in advance in the ROM 72 and is used for computing a blending rate (S305); and computes a blending rate by use of the distance function (S306). The distance function is a function used for determining a blending rate in accordance with a distance from a reference point while taking, as the reference point for a distance, an outer brim of a flashlight-exposed region or a boundary between the flashlight-exposed region and the unexposed region. FIG. 6 shows an example blending rate computed by use of a distance function. A horizontal axis represents a distance; namely, a distance between a pixel of interest and the closest boundary pixel. A certain blending rate assumes a value of 100% at the reference point. The greater the distance, the more the blending rate decreases linearly. A blending rate assumes a value of 0% at a threshold distance Rth (a function designated by reference numeral 100). Another blending rate decreases nonlinearly as the distance increases (a function designated by reference numeral 200). The blending rate is a mixing rate achieved when the flashlight-exposed region which is not subjected to restoration processing is merged with the unexposed region to be subjected to restoration processing. In order to make a boundary between the regions natural and unnoticeable when the regions are merged with each other, gradually changing the blending rate is preferable. An example distance function is a low-pass filter (LPF). The mask image is caused to pass through the low-pass filter, thereby continually changing and blurring the boundary of the mask image.

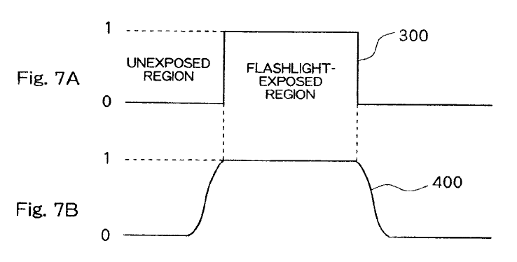

FIGS. 7A and 7B show an example mask image processed by use of a blending rate. FIG. 7A shows a pixel value of one horizontal line of an unprocessed mask image. Numeral “0” designates an unexposed region, and numeral “1” designates a flashlight-exposed region. FIG. 7B shows a single horizontal line of a processed mask image. The boundary between the flashlight-exposed region and the unexposed region changes continuously. The mask image processed by use of the blending rate is stored in the image memory e 68.

Meanwhile, the captured image stored in the image memory d 50 is supplied to the image restoration section 52, and an original image is restored by use of a PSF which is stored in the recording medium 26 and represents the amount of camera shake achieved during photography. The image restored by use of the PSF is stored in the image memory f 54 (S307). Restoration processing is performed while the entire image is taken as an object without distinguishing the flashlight-exposed region from the unexposed region. The image having undergone restoration processing is supplied to the multiplier 56. Further, the captured image stored in the image memory d 50 is supplied to the multiplier 70, as well.

The multiplier 70 multiplies the captured image not having undergone image restoration processing by the mask image stored in the image memory e 68 (S308). The mask image is a binary mask in which the flashlight-exposed region assumes a value of 1 and the unexposed region assumes a value of 0. As a result of the captured image being multiplied by the mask image, a pixel value of the flashlight-exposed region of the captured image still remains unchanged, and a pixel value of the unexposed region assumes a value of 0. Specifically, the mask image is an image achieved when only the flashlight-exposed region is extracted from the captured image. The flashlight-exposed region image is supplied to the adder 60.

The reference image, all pixel values of which assume a value of one, and the mask image are supplied to the subtractor 58. The subtractor 58 computes a difference between the reference image and the mask image, to create an inverted mask image. The inverted mask image is supplied to the multiplier 56. The multiplier 56 multiplies the captured image having undergone image restoration processing by the inverted mask image (S309). In the inverted mask image, the pixel value of the unexposed region assumes a value of 1, and the pixel value of the flashlight-exposed region assumes a value of 0. The inverted mask image is multiplied by the captured image, whereby only the unexposed region of the captured image is left. The pixel value of the flashlight-exposed region assumes a value of 0.

As mentioned above, the captured image not yet having undergone image restoration processing is multiplied by a mask image in S308, thereby extracting the flashlight-exposed region not having undergone image restoration. The captured image having undergone image restoration processing is multiplied by the inverted mask image in S309, to extract an unexposed region having undergone image restoration. The extracted regions are added by the adder 60, thereby blending the images (S310). As a distance from the boundary becomes greater, the blending rate becomes continually smaller. As a result, an image into which the flashlight-exposed region not yet having undergone image restoration and the unexposed region having undergone image restoration are merged with each other; namely, an image in which only the unexposed region has undergone image restoration processing, is acquired. The acquired image is stored in the image memory d 50 and further stored in the recording medium 26 (S311).

In the present embodiment, only the flash-unexposed region of the captured image is subjected to restoration processing. Hence, for instance, even when a person is photographed with a night view being taken as a background as in the case of a night portrait, there is acquired an image in which only camera shake in the background is corrected and the person exposed to flashlight is clear.

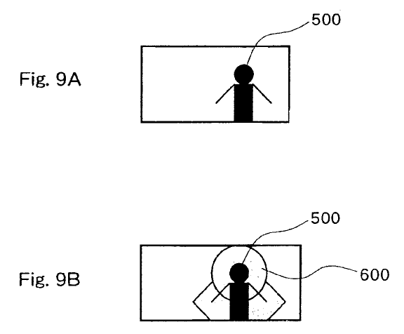

In the present embodiment, the flashlight-exposed region and the unexposed region are merged to create a single image. To this end, the blending rate is adjusted such that the boundary between the regions becomes unnoticeable. However, adjustment of the blending rate may also be omitted. Alternatively, the user may select whether to adjust the blending rate. Moreover, the blending rate may also be changed discontinuously; for instance, the blending rate is continuously changed according to a distance. Alternatively, a blending range may also be set according to the shape of a principal subject to be exposed to flashlight; for instance, the blending rate is changed according to a distance. FIGS. 9A and 9B show an example blending range set in accordance with the shape of a detected flashlight-exposed region. FIG. 9A shows a flashlight-exposed region 500; namely, a person who is the principal subject. FIG. 9B shows a blending range 600 set around the person who is the principal subject. In the set blending range 600, the blending rate continuously decreases with increasing distance toward the outer brim.

Moreover, in the present embodiment, the preview image is compared with the preview image acquired when preliminary flashlight is fired, or the preview image is compared with an image captured when primary flashlight is fired, thereby distinguishing a flashlight-exposed region from an unexposed region. However, the images may also be distinguished from each other by means of another method. For instance, an area located at a distance over which flashlight is considered to naturally reach the area may also be determined to be a flashlight-exposed region in accordance with data pertaining to a measured distance to a subject. Alternatively, a person which is a principal subject may also be automatically determined to be a flashlight-exposed region.

### PARTS LIST

10 optical system
12 CCD
14 AFE timing generator
16 selector
18 image memory a
20 selector
22 image processing
24 image memory c
26 recording medium
28 flash device
30 flash control
32 still preview section
34 image memory b
36 resize processing
38 region determination
40 mask image/path generation
42 memory controller
50 image memory d
52 image restoration
54 image memory f
56 multiplier
58 subtractor
60 adder
62 decoder
64 resize processing
66 rate computing section
68 image memory e
70 multiplier
72 ROM
500 flashlight-exposed region
600 blending range
700 camera shake
800 camera shake

What is claimed is:

1. An image restoration apparatus for subjecting an image captured through photography to restoration processing, the apparatus comprising:
detection means for detecting a flashlight-exposed region from an image captured by firing flashlight during photography; and
processing means for subjecting to restoration processing only an unexposed region of the captured image exclusive of the flashlight-exposed region detected by the detection means.

2. The image restoration apparatus of claim 1, wherein the detection means detects the flashlight-exposed region by use of a preview image acquired when flashlight is not fired.

3. The image restoration apparatus of claim 2, wherein the detection means compares the preview image acquired when flashlight is not fired with a preview image captured when preliminary flashlight is fired, thereby detecting the flashlight-exposed region.

4. The image restoration apparatus of claim 2, wherein the detection means compares the preview image acquired when flashlight is not fired with an image captured when flashlight is fired, thereby detecting the flashlight-exposed region.

5. The image restoration apparatus of claim 1, wherein the processing means extracts the flashlight-exposed region of the captured image, subjects the unexposed region of the captured image to restoration processing, and merges the flashlight-exposed region having not undergone restoration processing with the unexposed region having undergone restoration processing.

6. The image restoration apparatus of claim 1, wherein the processing means extracts the flashlight-exposed region of the captured image, extracts the unexposed region after having subjected the captured image to restoration processing, and merges the extracted regions with each other.

7. The image restoration apparatus of claim 6, wherein, when merging the extracted regions with each other, the processing means performs merging at a merging rate which continually changes in accordance with a distance from a boundary between the flashlight-exposed region and the unexposed region.
